(19) United States
(12) Patent Application Publication
(10) Pub. No.: US 2023/0106011 A1
(43) Pub. Date: Apr. 6, 2023

(54) Secure QR code system for distributed large payload transmissions for everyday use

(71) Applicant: Georgia Tech Research Corporation, Atlanta, GA (US)

(72) Inventors: Vitaly Marin, Atlanta, GA (US); Raheem Abdul Beyah, Atlanta, GA (US); Charles Isbell, Atlanta, GA (US)

(21) Appl. No.: 17/794,868

(22) PCT Filed: Feb. 1, 2021
(86) PCT No.: PCT/US21/16031

§ 371 Date: Jul. 22, 2022

Related U.S. Application Data
(60) Provisional application No. 62/967,691, filed on Jan. 30, 2020.

(51) Int. Cl. G06K 7/14; H04M 1/72427; G06V 30/40; G06F 21/60

(52) U.S. Cl. CPC G06K 7/1421; H04M 1/72427; G06V 30/40; G06K 7/1443; G06F 21/602; H04M 2250/52

(57) ABSTRACT

A system for transferring a data file includes a first data device (124) that is configured to: partition the data file (200) into a plurality of sub-units (202); generate a plurality of sequence bits (211) for each sub-unit that indicates a place in the data file (200) that the sub-unit belongs; for each sub-unit, integrate the sequence bits into the sub-unit; and convert each sub-unit into a different sub-unit QR code (221), thereby generating a plurality of sub-unit QR codes (221, 222 . . . 229); and transmit each of the sub-unit QR codes (221, 222 . . . 229). A second data device (130) is configured to: receive each of the sub-unit QR codes (221, 222 . . . 229); convert each of the sub-unit QR codes (221, 222 . . . 229) into corresponding reconstructed sub-units; and assemble the reconstructed sub-units nto a reconstructed data file (110′) in an order indicated by the sequence bits.

### CROSS-REFERENCE TO RELATED APPLICATION(S)

This application claims the benefit of U.S. Provisional Patent Application Ser. No. 62/967,691, filed Jan. 30, 2020, the entirety of which is hereby incorporated herein by reference.

### BACKGROUND OF THE INVENTION

### 1. Field of the Invention

The present invention relates to data transmission systems and, more specifically, to a data transmission system that transmits data in the form of a QR code.

### 2. Description of the Related Art

There are situations in which data is to be transmitted to an individual in which the data must be made readily available, such as through projection. In certain situations, it is desirable for the individual receiving the data to be able to quickly capture the data using a smart phone or other camera-equipped device. If the data is in the form of text, capturing it and converting it to a text document can be time consuming. Also, there are situations in which it is desirable to project data in a secure manner so that only an authorized receiver can acquire the projected data.

Quick Response (QR) codes are a type of two-dimensional barcode that displays a matrix of bits to encode data with four standardized encoding modes (numeric, alphanumeric, byte/binary, and kanji). A QR code can be generated quickly from input data and the data in a QR code can be extracted quickly by any device with a QR code decoder. A visual image of a QR code can be displayed easily, such as on a screen or by a projector. Most smart phones include a camera that can capture a printed QR code and a processor that can extract the data in the captured QR codes.

Many people use QR codes to read text and write data for personal and business uses. While a QR code's payload data can be encrypted, the actual useful data in payload is limited by the payload's inherent size limitation and the overhead of the encryption itself.

Therefore, there is a need for a system that securely projects data to a user.

### SUMMARY OF THE INVENTION

The disadvantages of the prior art are overcome by the present invention which, in one aspect, is a system for transferring a data file that includes a first data device and a second data device. The first data device is configured to: partition the data file into a plurality of sub-units; generate a plurality of sequence bits for each sub-unit that indicates a place in the data file that the sub-unit belongs; for each sub-unit, integrate the sequence bits into the sub-unit; and convert each sub-unit into a different sub-unit QR code, thereby generating a plurality of sub-unit QR codes; and transmit each of the sub-unit QR codes. The second data device is configured to: receive each of the sub-unit QR codes from the first data device; convert each of the plurality of sub-unit QR codes into corresponding reconstructed sub-units; and assemble the reconstructed sub-units into a reconstructed data file in an order indicated by the sequence bits.

In another aspect, the invention is an apparatus for transferring a data file that includes a device that coverts the data file into a QR code, a device that transmits the QR code, a device that receives the QR code and a device that generates reconstructed data file from the QR code.

In yet another aspect, the invention is a method of transferring a data file, in which the data file is converted into a QR code and then transmitted. The QR code is received and a reconstructed data file is generated from the QR code.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram showing one representative embodiment of a data communication system using a QR code.

FIG. 1B is a schematic diagram showing one representative embodiment of a data format employed in the data communication system shown in FIG. 1A.

FIG. 2A is a schematic diagram showing one representative embodiment of a large file data communication system using QR codes.

FIG. 2B is a schematic diagram showing a plurality of QR codes being transmitted.

FIG. 2C is a schematic diagram showing a handshaking system for transmitting a large data file with a plurality of QR codes.

FIG. 3A is a schematic diagram showing a smart phone capturing data from a document and converting it into a QR code.

FIG. 3B is a schematic diagram showing a system for capturing, transmitting a recovering data using a QR code.

FIG. 4 is a schematic diagram showing a system that compresses and encrypts data and then converts the data into a QR code.

FIG. 5 is a schematic diagram showing close proximity data transmission to a cell phone using a QR code data transmission system.

FIG. 6A is a schematic diagram showing assembly of QR code sub-unit files being assembled into an animated graphics interchange format file.

FIG. 6B is a schematic diagram showing transmission of animated graphics interchange format file shown in FIG. 6A.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

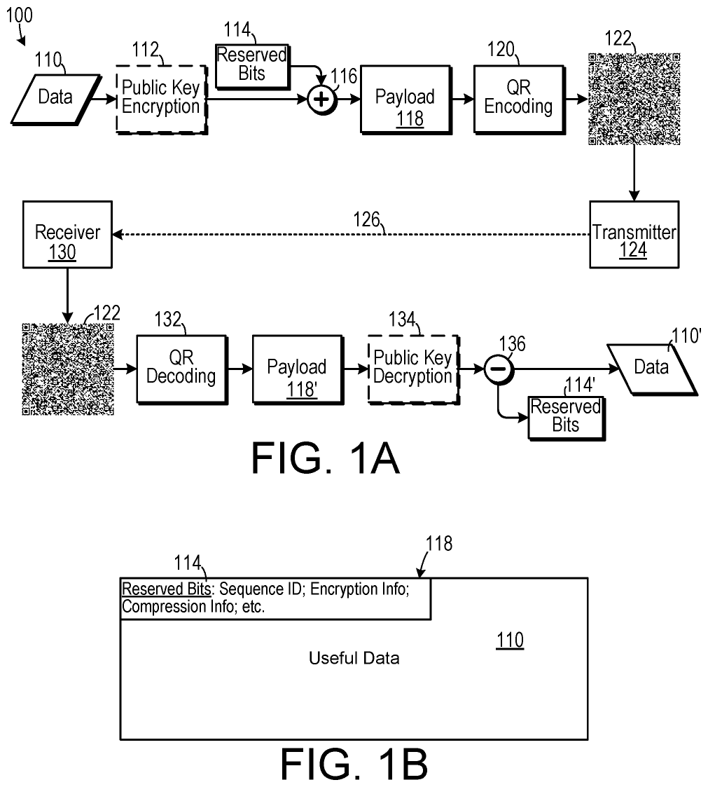

As shown in FIG. 1A, in one representative embodiment of a data transmission system 100, a data file 110 (e.g., a text file) can optionally be encrypted 112 (e.g., using an encryption system such as an SHA-2-type system) and reserved bits 114 can be added 116 to generate a payload file 118. The reserved bits 114 can include metadata regarding, for example, compression and encryption methods used, which can then be used in decompressing and decrypting the data. (Some of the reserved bits can be added before the encryption step so that only reserved bits regarding the encryption standard used remain unencrypted.) As will be discussed in more detail below, the reserved bits 114 can also include sequence bits or pointers used to reconstruct the data file 110 from partitioned sub-units of the data file 110. The payload file 118 is converted into at least one QR code 122, which is then transmitted by a transmitting data device 124 (such as a projector, a video screen, etc.) over a channel 126 (such as a visual transmission medium). A receiving data device 130 (such as a computer with a camera, a smart phone with a camera, a tablet with a camera, a digital device with a scanner, etc.) receives the QR code 122′ and decodes 132 the received QR code 122′ to generate a reconstructed payload file 118′. If the file had been encrypted, then it is decrypted 134 by processing the metadata reserved bits relating to encryption. Once decrypted, the reserved bits 114 are removed so as to generate a reconstructed data file 110′. As shown in FIG. 1B, the data format for the payload 118 can include the original useful data 110 and the reserved bits 114 appended thereto. While FIG. 1A shows unidirectional QR code communication, it is understood that bidirectional QR code communication can also be performed using the embodiments of the present invention.

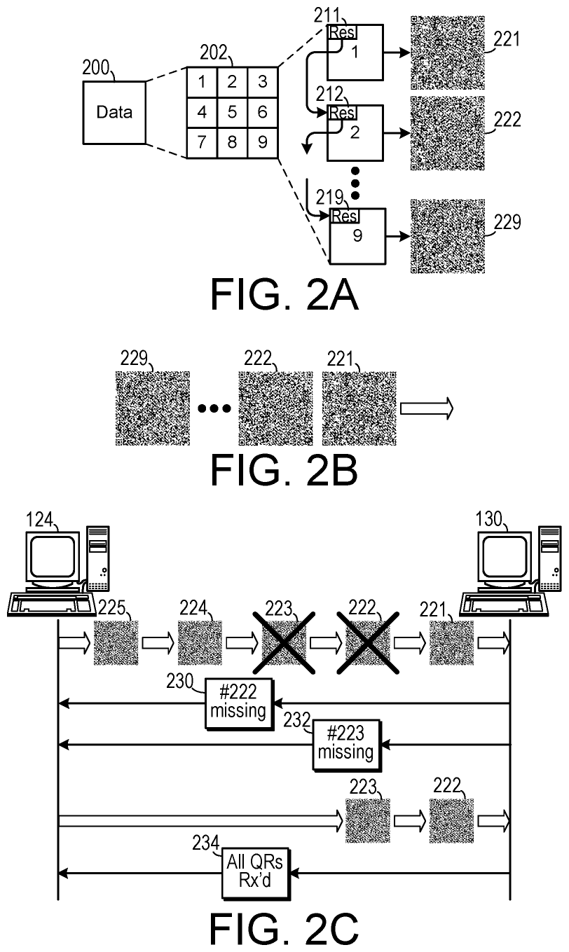

As shown in FIG. 2A a large data file 200 can be partitioned into a plurality of sub-unit files 202 (also referred to as “chunks”). Each sub-unit file 1, 2, . . . 9 would include reserved bits 211, 212, . . . 219 (respectively) that indicate their position in the sequence of partitions. Each resulting file is then encoded in a different QR code 221, 222, . . . 229 (respectively). As shown in FIG. 2B, the different QR codes 221, 222, . . . 229 are transmitted. They can be transmitted synchronously or, if the reserved bits include file position information (e.g., sequence pointers) they can be transmitted asynchronously. As shown in FIG. 2C, a handshaking routine can be implemented between the transmitting device 124 and the receiving device 130 to ensure data integrity. In this example, the transmitting device 124 transmits five QR codes 221, 222, 223, 224 and 225. However, QR codes 222 and 223 are lost in transmission or are received as corrupted data. By decoding the remaining QR codes and examining their reserved bits, the receiving device 130 determines that QR codes 222 and 223 need to be retransmitted. It then sends indications 230 and 232 (which can be encrypted for added security) of the missing QR codes to the transmitting device 124, which then resends the missing QR codes 222 and 223. Once received, the receiving device 130 sends an acknowledgement 234 indicating that the entire transmission has been received.

When partitioning a large file, each sub-unit file can be encrypted, compressed or both independently, with the necessary reserved bits appended thereto, prior to encoding the sub-units. By doing this, the receiving device can decode, decrypt and expand each sub-unit independently, without having to wait for all sub-units to be received. This can be useful in situations where one of the sub-units in a sequence is corrupted during transmission. Alternatively, the entire large file can be encrypted, compressed or both prior to its being partitioned. Processing the entire large file at once may be more computationally efficient, whereas processing sub-units independently may be useful where quick access to portions of the data file is desirable. When encrypting different sub-units independently, each sub-unit can be encrypted with a common key or they can be encrypted with different keys if heightened security is desirable.

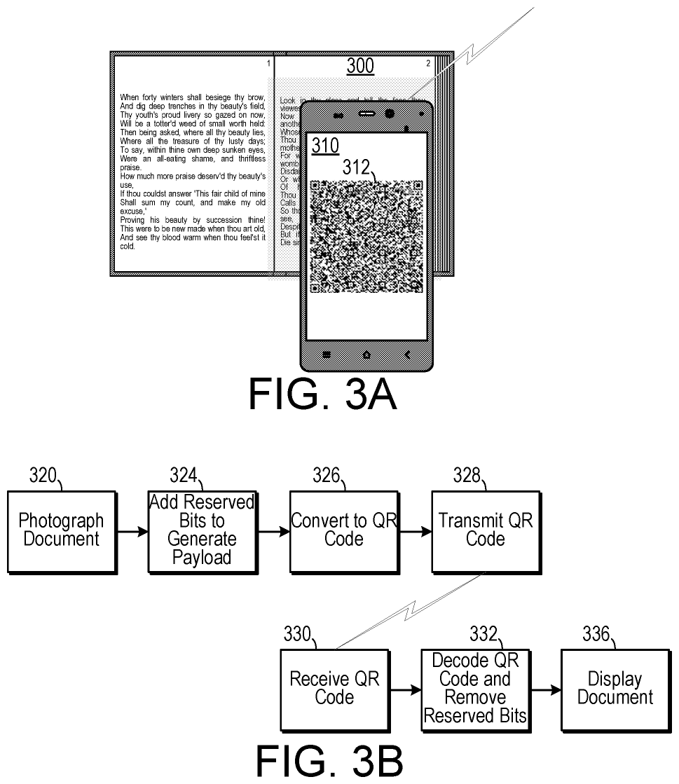

As shown in FIGS. 3A and 3B, in one embodiment, the system can be used to transmit documents. In this embodiment, a camera in a device such as a smart phone 310 photographs the document 300 and then a processor converts it into a QR code 312, which is then transmitted to another device. Optionally, the processor can use a text recognition routine to convert the document image into text prior to generating the QR code 312. In this embodiment, the document is photographed 320, any necessary reserved bits are added to the image file to generate the payload 324, the payload is converted to a QR code 326 and the QR code is transmitted 328. The receiving device receives the QR code 330, decodes the QR code, removes any reserved bits 332 and then displays the document 336 or otherwise uses it as appropriate.

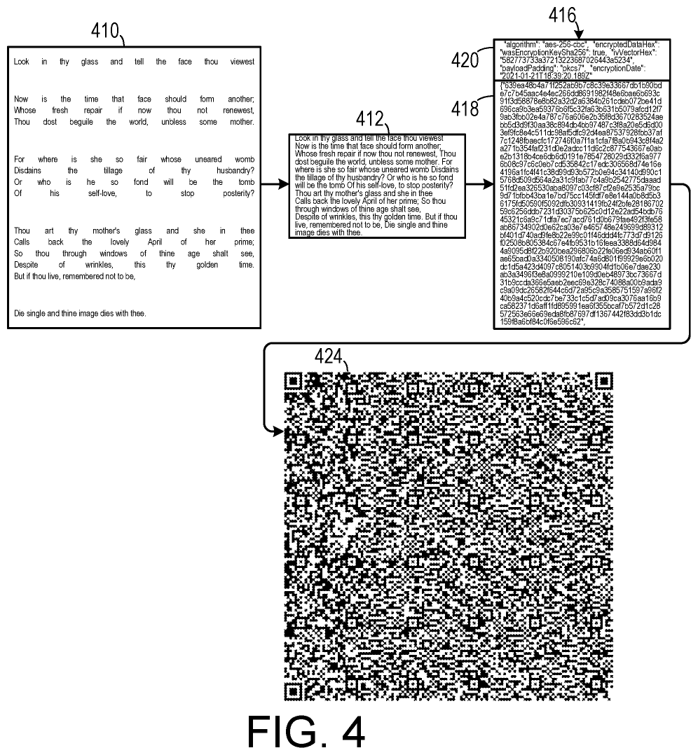

As shown in FIG. 4, the source data file 410 can be compressed 412 using any of the data compression routines commonly known. It can also be encrypted using a known encryption routine (such as, for example, a public key encryption routine) to generate an encrypted file 416 that includes both encrypted data 418 and reserved bits 420 with metadata necessary to decrypt the document. In some embodiments, the data file can be both compressed and encrypted. The resulting file is then converted into a QR code 424 that is ready for transmission.

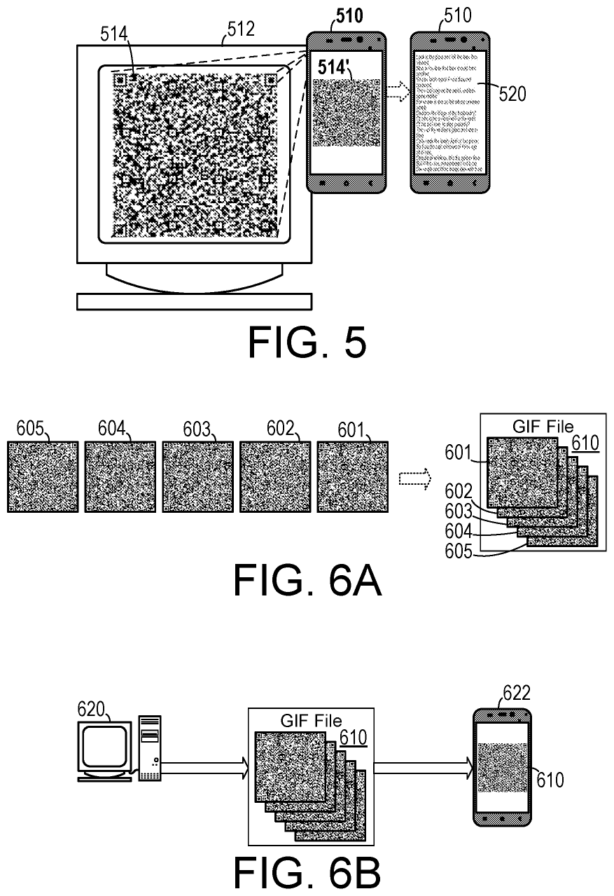

As shown in FIG. 5, the QR codes 514 can be displayed on a device such as a screen 512. A user can then photograph the QR code 514 with a portable receiving device, such as a smart phone 510, which generates a captured QR code 514′. The receiving device can then decode the captured QR code 514′ to reconstruct the useful data 520.

As shown in FIGS. 6A and 6B, the transmitting device can convert a large data file into a plurality sub-file units and generate a corresponding plurality of QR codes 601, 602, 603, 604 and 605, which are then assembled into an animated visual file 610, such as a graphics interchange (GIF) format file. It can then “play” the animated visual file 610 by displaying the QR codes 601, 602, 603, 604 and 605 in sequence. The receiving device 622 can then record the playback of the animated visual file 610 and decode the captured QR codes 601, 602, 603, 604 and 605.

The present invention allows a sender of data to transmit visually-perceptible copies of the data that can easily be acquired by a user of the data. It also allows large files to be visually transmitted. Additionally, it allows secure transmission of the data. It improves data transmission over visual transmission means.

Distributing the QR code payload's data across numerous QR codes linked together enables one to embed very large payload of data across several QR codes. Also, the data payloads can be compressed and encrypted for security via public key encryption. Furthermore, distributed payload in QR codes can be transmitted visually as a stream of QR codes either in a grid, or as pairs or singles from one device to another (smart phones, tablets, etc.) using only camera and display. Such distributed payload transmission using QR codes can occur synchronously or asynchronously. Asynchronous transmission can be used, for example, when a single frame (single, pair or grid QR code) is being transmitted. Synchronous transmission can be used, for example, when a stream of QR codes are being transmitted. Synchronous transmission of QR codes tends to protect data transmission from accidentally corrupted QR codes via a retransmission, from varying the speed of transmission, and from varying the size of the QR code's payload (or other parameters) to minimize decoding errors at the receiving device. Error minimization for a dropped number of QR codes can be accomplished via machine learning, deep learning, and reinforced learning techniques. Some QR codes' payloads can be used for servicing the synchronous transmission for purposes to signal the beginning of the QR code stream transmission, end of the transmission, what frames have been transmitted, to negotiate the transfer rate, request for retransmission, or the acknowledgement of receival of specific QR code frame, for example. For synchronous transmission both devices should have a camera and a display.

The system of the present invention can be applied to many different uses. For example, it can be used with the following: secure QR codes with large payloads, secure email, secure fax, secure print, secure remote desktop, printed books for the blind, electronic books for the blind, electronic TV capture for the blind, video capture for the blind. secure chat messages in forums, secure books and or other applications.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A system for transferring a data file, comprising:
(a) a first data device configured to:
(i) partition the data file into a plurality of sub-units;
(ii) generate a plurality of sequence bits for each sub-unit that indicates a place in the data file that the sub-unit belongs;
(iii) for each sub-unit, integrate the sequence bits into the sub-unit;
(iv) convert each sub-unit into a different sub-unit QR code, thereby generating a plurality of sub-unit QR codes; and
(v) transmit each of the sub-unit QR codes; and
(b) a second data device configured to:
(i) receive each of the sub-unit QR codes from the first data device;
(ii) convert each of the plurality of sub-unit QR codes into corresponding reconstructed sub-units; and
(iii) assemble the reconstructed sub-units into a reconstructed data file in an order indicated by the sequence bits.

2. The system of claim 1, wherein the first data device is further configured to assemble the plurality of sub-unit QR codes into an animated visual file and wherein the first data device transmits each of the sub-unit QR codes by transmitting the animated visual file.

3. The system of claim 2, wherein the animated visual file comprises a graphics interchange format file.

4. The system of claim 1, wherein the first data device includes a processor and a transmitter and wherein the second data device includes a processor and a receiver.

5. The system of claim 1, wherein at least one of the first data device the second data device comprises a smart phone.

6. The system of claim 5, wherein the smart phone is configured to photograph a document and then recognize text in the document so that the data file includes the text.

7. The system of claim 1, wherein the first data device is further configured to add a plurality of reserved bits to the data file prior to converting the data file into at least one of the QR codes, wherein the reserved bits include metadata regarding the data file; and wherein the second data device is configured to remove the reserved bits from the reconstructed data file and to further process the reconstructed data file based on the metadata in the reserved bits.

8. The system of claim 7, wherein the first data device is further configured to compress the data file into a compressed data file and wherein the metadata comprises information used by the second data device to decompress the compressed data file.

9. The system of claim 1, wherein the first data device is further configured to encrypt the data file into an encrypted data file and wherein the metadata comprises information regarding used by the second data device to decrypt the encrypted data file.

10. An apparatus for transferring a data file, comprising:
(a) means for converting the data file into a QR code;
(b) means for transmitting the QR Code;
(c) means for receiving the QR code; and
(d) means for generating a reconstructed data file from the QR code.

11. A method of transferring a data file, comprising the steps of:
(a) converting the data file into a QR code;
(b) transmitting the QR Code;
(c) receiving the QR code; and
(d) generating a reconstructed data file from the QR code.

12. The method of claim 11, further comprising the steps of:
(a) photographing a document;
(b) recognizing text in the document;
(c) generating the data file so as to include the text.

13. The method of claim 12, wherein the photographing step includes photographing the document with a smart phone with a camera.

14. The method of claim 11, further comprising the steps of:
(a) generating a plurality of reserved bits that include metadata regarding the data file before the step of converting the data file into a QR code; and
(b) adding the reserved bits to the data file between the step of converting the data file into a QR code and the step of transmitting the QR code.

15. The method of claim 14, further comprising the steps of:
(a) removing the reserved bits from the reconstructed data file; and
(b) further processing the reconstructed data file based on the metadata in the reserved bits.

16. The method of claim 15, further comprising the steps of:
(a) compressing the data file into a compressed data file before the step of converting the data file into a QR code; and
(b) decompressing the compressed data file using the metadata.

17. The method of claim 15, further comprising the steps of:
(a) encrypting the data file into an encrypted data file before the step of converting the data file into a QR code; and
(b) decrypting the encrypted data file using the metadata.

18. The method of claim 11, further comprising the steps of:

19. The method of claim 11, wherein the first data device is further configured to:
(a) partitioning the data file into a plurality of sub-units;
(b) generating a plurality of sequence bits for each sub-unit that indicates a place in the data file that the sub-unit belongs;
(c) for each sub-unit, integrating the sequence bits into the sub-unit;
(d) converting each sub-unit into a different sub-unit QR code, thereby generating a plurality of sub-unit QR codes; and
(e) transmitting each of the sub-unit QR codes.

20. The method of claim 19, further comprising the step assembling the plurality of sub-unit QR codes into a single graphics interchange format file, wherein the step of transmitting each of the sub-unit QR codes comprises transmitting the single graphics interchange format file.

21. The method of claim 19, further comprising the steps of:
(a) converting each of the plurality of sub-unit QR codes into corresponding reconstructed sub-units; and
(b) assembling the reconstructed sub-units into a reconstructed data file in an order indicated by the sequence bits.

22. The method of claim 19, further comprising the step of encrypting each sub-unit independently using a common key prior to the step of converting each sub-unit into a different sub-unit QR code.
